(19) United States
(12) Patent Application Publication
(10) Pub. No.: US 2026/0223816 A1
(43) Pub. Date: Aug. 6, 2026

(54) A LIGHTING DEVICE FOR ILLUMINATING AN ANIMAL STABLE

(71) Applicant: SIGNIFY HOLDING B.V., EINDHOVEN (NL)

(72) Inventors: JACK TIEBERG, PLYMOUTH, MN (US); AARON BENJAMIN STEPHAN, CHANHASSEN, MN (US); MARC ANDRE DE SAMBER, LOMMEL (BE); CURTIS ALLEN LEYK, ALBANY, MN (US); DRAGAN SEKULOVSKI, EINDHOVEN (NL); HARRY BROERS, "S-HERTOGENBOSCH (NL)

(21) Appl. No.: 19/155,587

(22) PCT Filed: Feb. 5, 2024
(86) PCT No.: PCT/EP2024/052781

§ 371 Date: Aug. 12, 2025

Related U.S. Application Data
(60) Provisional application No. 63/445,094, filed on Feb. 13, 2023.

(30) Foreign Application Priority Data
Mar. 28, 2023 (EP) 23164654.8

(51) Int. Cl. A01K 15/02; A01K 31/22

(52) U.S. Cl. CPC A01K 15/02; A01K 31/22

(57) ABSTRACT

The invention provides a lighting device for illuminating an animal stable, wherein the lighting device comprises a projection unit and a control unit; wherein the projection unit is configured to project a dynamic light spot within the animal stable for a period of time, wherein the period of time comprises a first subperiod followed by a second subperiod; wherein the control unit is configured to control the projection unit, during the first subperiod of time, to project the dynamic light spot moving with a pseudorandom or random movement that is confined to a first surface area within the animal stable; and wherein the control unit is configured to control the projection unit, during the second subperiod of time, to project the dynamic light spot moving with a curvilinear or linear movement out from the first surface area.

### FIELD OF THE INVENTION

The invention relates to a lighting device for illuminating an animal stable. The invention further relates to a corresponding method of illuminating an animal stable, and to an animal stable comprising at least one lighting device according to the invention.

### BACKGROUND OF THE INVENTION

Even though poultry farming is traditionally driven by economics of scale and optimizing production efficiency, the topic of animal health and wellbeing is getting more and more traction within modern poultry farming. It is found that improved animal health and wellbeing has a positive outcome on commodities produced from raising poultry (such as for example eggs, feathers, and/or meat).

One known mechanism for improving the health and wellbeing of poultry is to encourage movement or exercise for the poultry. This may be of particular relevance to broiler chicken, for example, because commercial broiler chicken have been genetically selected for fast growth and heavy breast muscles. This combination leads to a phenotype in which the birds grow large very fast, inevitably resulting in increased leg/mobility issues.

One solution for encouraging broiler chicken movement or exercise is environmental enrichment, a concept wherein laser spots are projected on a poultry coop bedding, either stationary or moving, so as to render a (curious) response from the broiler chicken, that gets the broiler chicken moving. See e.g.: Meyer, M. M., A. K. Johnson, and E. A. Bobeck. 2019. “A Novel Environmental Enrichment Device Improved Broiler Performance without Sacrificing Bird Physiological or Environmental Quality Measures.” Poultry Science 98 (11): 5247-56.

Environmental enrichment with such projected laser spots is implemented with a random or a pseudorandom movement pattern of the spots. The effectiveness of such environmental enrichment, and the resulting benefits to animal health and wellbeing, may be negatively affected (over time) by habituation of the animals (i.e. e.g. poultry) to the random or pseudorandom movement pattern of the spots. Hence, it is a desire to not only attract the attention (curious response) of the animals (i.e. e.g. poultry) therewith, but even further improve on encouraging movement or exercise.

### SUMMARY OF THE INVENTION

It is an object of the invention to provide an improved lighting device, which at least alleviates the problems and disadvantages mentioned above. Thereto, the invention provides, a lighting device for illuminating an animal stable, wherein the lighting device comprises a projection unit and a control unit; wherein the projection unit is configured to project a dynamic light spot within the animal stable for a period of time, wherein the period of time comprises a first subperiod followed by a second subperiod; wherein the control unit is configured to control the projection unit, during the first subperiod of time, to project the dynamic light spot moving with a pseudorandom or random movement that is confined to a first surface area within the animal stable; and wherein the control unit is configured to control the projection unit, during the second subperiod of time, to project the dynamic light spot moving with a curvilinear or linear movement out from the first surface area and in a direction away from a center of the first surface area.

Hence, the invention provides a lighting device for illuminating an animal stable. The animal stable may be a poultry coop. The animal stable may comprise at least one animal, such as poultry, such as for example at least one broiler chicken. Hence, in the present application, preferably, the at least one animal may be a broiler chicken(s).

The lighting device comprises a projection unit and a control unit. The projection unit may be communicatively coupled to the control unit. The projection unit is configured to project a dynamic light spot within the animal stable for a period of time. The control unit is configured to control the projection unit. Said period of time comprises a first subperiod followed by a second subperiod. The period of time thereby defines the period of time that a particular dynamic light spot is projected. The dynamic light spot may enable environmental enrichment for at least one animal within the animal stable, such as poultry, like for example broiler chicken.

Since the control unit is configured to control the projection unit, during the first subperiod of time, to project the dynamic light spot moving with a pseudorandom or random movement that is confined to a first surface area within the animal stable, the lighting device according to the invention enables a first stage (of projection of the dynamic light spot) in which the attention of an animal (e.g. poultry) is attracted (and environmental enrichment is provided) within the first surface area.

However, since the control unit is further configured to control the projection unit, during the second subperiod of time, to project the dynamic light spot moving with a curvilinear or linear movement out from the first surface area, the lighting device according to the present invention advantageously enables a second stage (of projection of the dynamic light spot) subsequent to the first stage, in which the second stage encourages an animal (e.g. poultry) to follow the projected dynamic light spot along a defined pathway, namely to move along a curvilinear or linear path out of the first surface area.

Hence, the lighting device according to the present invention enables environmental enrichment wherein the dynamic light spots are projected in two subsequent stages. Thereby, the first stage being configured to trigger curiosity and attract attention of at least one animal within the first surface area, while the following second stage is configured to entice the at least one animal to move out of the first surface area along a curvilinear or linear path that is easier to follow than a pseudorandom or random pathway. This improves movement, thereby the Musculo-skeletal development, of the at least one animal, such as poultry, like for example broiler chicken. Thus, the present invention provides a lighting device that improves environmental enrichment.

The first subperiod may thereby be characterized as (or phrased as) an attention-grabbing stage of at least one animal, while the second subperiod may be characterized as (or phrased as) a locomotion stage of at least one animal.

The movement out from the first surface area may alternatively be phrased as movement away from of the first surface area and out of the first surface area. The movement out from the first surface area may alternatively be phrased as movement out from the first surface area and in a direction away from a center of the first surface area. Said center being a centroid of the first surface area.

Moreover, as partly mentioned, the animal stable may comprise at least one animal. Therefore, the lighting device according to the present invention may be arranged for illuminating the animal stable and/or at least one animal within the animal stable. The at least one animal may most preferably be poultry. The at least one animal may for example be a flock of birds, or a plurality of diurnal avians, or at least one chicken, or at least one broiler chicken or layer chicken. The concepts of the present invention are not limited to poultry, but may also be envisioned for other animals, such as for example pigs. The animal stable may alternatively be phrased as an agricultural environment, or a livestock environment, or a livestock space.

The animal may preferably be a bird. Said bird may for example be a chicken, or one or more of: Turkeys, Ducks, Geese, Pheasant, Quail, Guinea Fowl, Heritage Breed Chickens, Pet Birds, Songbirds.

In an embodiment, the lighting device according to the embodiment may be a luminaire. Such a luminaire may comprise a luminaire housing, wherein the luminaire housing may comprise the projection unit and/or the control unit. The luminaire may optionally comprise a light source for providing ambient lighting. Said ambient lighting may for example illuminate the animal stable with an animal lighting recipe, in addition to the lighting unit projecting the dynamic light spot(s) enabling said environmental enrichment. For example, said ambient lighting may comprise the trademarked Junglite Green light recipe of the company Signify-ONCE.

Hence, in an embodiment, the lighting device may comprise a light source; wherein the light source is configured to illuminate the animal stable with ambient light. Said ambient light may comprise an animal light recipe. In a further embodiment, the lighting device may be a luminaire comprising a luminaire housing, wherein the luminaire housing comprises the light source, the projection unit, and the control unit.

In an embodiment, the projection unit may be a laser lighting unit, wherein the dynamic light spot may be a dynamic laser light spot. In an embodiment, the projection unit may be a high-etendue spotlight, wherein the dynamic light spot is a high-etendue dynamic light spot. The projection unit may further for example be a projector or a LED spotlight.

In an embodiment, the period of time may be at most thirty seconds. In an embodiment, a time duration of the first subperiod may be at least a factor two longer than a time duration of the second subperiod. For example, if the period of time is thirty seconds, the first subperiod may be twenty seconds, and the second subperiod may be ten seconds, thereby enabling the first subperiod to attract the attention of the at least one animal during a longer timespan before encouraging the at least one animal to move along said curvilinear or linear path.

In an embodiment, the lighting device according to any one of the preceding claims, wherein the curvilinear or linear movement may comprise a path length; wherein the path length is at least two meters. For example, the path length may be at least two meters, such as for example at least four meters. Considering the second subperiod characterizes a locomotion stage of at least one animal, the projecting unit projecting the dynamic light spot moving with a curvilinear or linear movement out from the first surface area allows for easier to track and longer trajectories for the at least one animal. Hence, such a locomotion stage is not only beneficial to render health and wellbeing to the at least one animal, due to the enticed physical movement, but also enables relocation of the at least one animal from the first surface area to another area of interest within in the animal stable.

In an embodiment, the control unit may be configured to control the projection unit, during the first subperiod of time, to project the dynamic light spot moving with the pseudorandom or random movement at a first movement speed; wherein the control unit may be configured to control the projection unit, during the second subperiod of time, to project the dynamic light spot moving with the curvilinear or linear movement out from the first surface area at a second movement speed; wherein the first movement speed is different from the second movement speed. The first movement speed may be tailored to attract the attention of at least one animal. The second movement speed may be tailored to encourage the at least one animal to move away, and out of the first movement area.

In an embodiment, the second movement speed may be larger than the first movement speed. Such a larger movement speed enables to cover larger distances in the same or less time, which at least one animal may follow, thereby rendering an increased movement and/or exercise. For example, in an embodiment, the first movement speed may be selected from the range between five and ten centimeter per second. For example, in an embodiment, the second movement speed may be selected from the range between ten and thirty centimeter per second.

The first surface area may be part of a stable surface area, such as for example a part of the bedding or floor of the animal stable. The first surface area may be a geometric shape, such as a circle, a square, an ellipse, a polygon. The first surface area may alternatively be a free form shape, such as an organic shape. In an embodiment, the first surface area is at most 0.1 square meter.

The first surface area is a confined area onto which the dynamic light spot(s) with the pseudorandom or random movement pattern are projected by the projection unit during the first subperiod. The first surface area may be predefined. A predefined first surface area may be defined during installation and/or commissioning of the lighting device.

In aspects, the control unit may be configured to obtain a heatmap indicative of the distribution of animals within the animal stable, and determine the first surface area based on said heatmap. Hence, the first surface area may be an area comprising a number of animals exceeding a predefined number, or exceeding a predefined animal density.

The first surface area may comprise a contour (or: outline). Hence, the control unit may be configured to control the projection unit, during the first subperiod of time, to project the dynamic light spot moving with a pseudorandom or random movement confined within the contour (or: outline) of the first surface area within the animal stable. Moreover, the control unit may be configured to control the projection unit, during the second subperiod of time, to project the dynamic light spot moving with a curvilinear or linear movement out from the contour (or: outline) of the first surface area.

In an embodiment, the projection unit may be configured to project the dynamic light spot with a lighting characteristic, wherein said lighting characteristic may be at least one of: a light intensity, a light color, a light spectrum, a color temperature, a light polarization. Throughout the application, the phrase ‘light characteristic’ may alternatively be phrased as ‘light property’.

For example, in an embodiment, the projection unit may be configured to project the dynamic light spot with a lighting characteristic, wherein the lighting characteristic comprises ultraviolet light. In other words: the dynamic light spot is an ultraviolet dynamic light spot. The visual response of poultry includes sensitivity for ultraviolet light, in contrast to humans. Therefore, projecting the dynamic light spot with a lighting characteristic comprising ultraviolet light, enables poultry to react to the dynamic light spot(s) while these remain invisible to humans in the animal stable, thereby not distracting said humans. Said ultraviolet light may for example be UV-A light or UV-B light, substantially harmless to humans.

In an alternative example, said lighting characteristic may be a light intensity of at least 20 lumens, such as at least 50 lumens. When an animal stable, such as a poultry coop, utilizes dimmed lighting conditions, the dynamic light spots having at least 20 lumens, such as at least 50 lumens, may be more noticeable for the animal(s), such as the poultry.

In an embodiment, the control unit is configured to obtain a sensor input signal indicative of an activity level of animals within the animal stable and determine said activity level; wherein the control unit is configured to control the projection unit to project the dynamic light spot within the animal stable for said period of time if the determined activity level is below a predefined threshold value. Since the activity level of the animals within the animal stable is indicative of their current movement and/or exercise, such an embodiment is advantageous, because the projection of the dynamic light spot within the animal stable for said period of time only occurs upon determining that the activity level is below a predefined threshold value. Hence, the environmental enrichment will only, purposefully, be controlled (or: performed) when more movement of the animal(s) are required. Said animal(s) may for example be poultry, chicken, or more specifically be broiler chicken.

In an embodiment, the control unit is configured to obtain a sensor input signal indicative of an animal density within the animal stable and determine said animal density; wherein the control unit is configured to control the projection unit to project the dynamic light spot within the animal stable for said period of time if the determined animal density is above a predefined threshold value.

In an embodiment, the control unit is configured to obtain a sensor input signal indicative of an animal presence within the animal stable and determine said animal presence; wherein the control unit is configured to control the projection unit to project the dynamic light spot within the animal stable for said period of time if the animal presence is determined.

In a further embodiment, the control unit is configured to obtain a sensor input signal indicative of an activity level of animals within the animal stable at a first moment in time and determine said activity level at said first moment in time; wherein the control unit is configured to control the projection unit to project the dynamic light spot within the animal stable for said period of time if the determined activity level at said moment in time is below a predefined threshold value and if said moment in time falls within a predetermined period of time. For example, said predetermined period of time may be the day period of a circadian cycle of poultry, such that environmental enrichment with the use of said dynamic light spots is provided during the day (when the poultry are awake). For example, said predetermined period of time may be the night period of a circadian cycle of poultry, such that environmental enrichment with the use of said dynamic light spots is provided during the night (only for the poultry that are awake during night and require exercising); wherein additionally and optionally the dynamic light spots in such an embodiment may comprise ultraviolet light, such that these are visible to the chicken during night without illuminating the animal stable with visible light. Moreover, for example, said predetermined period of time may be a feeding period of the at least one animal, such as the feeding period of the chicken. Moreover, for example, said predetermined period of time may be a post-feeding period of the at least one animal, such as the post-feeding period of the chicken, which post-feeding period starts after the end of a feeding period of the animal(s)/chicken so as to provide a lighting device that encourages more movement after feeding.

The animals may be moved along said curvilinear or linear path out of the first surface area to another surface area. Said another surface area may be a feeding and/or drinking location. Hence, in further embodiments, the period of time may comprise a third subperiod following the second subperiod; wherein the control unit is configured to control the projection unit, during the third subperiod of time, to project the dynamic light spot moving with a pseudorandom or random movement that is confined to a third surface area within the animal stable; wherein the third surface area is outside the first surface area; wherein the third surface area is at a distance from the first surface area. Such an embodiment may be advantageous to get animals moving, but also to redistribute said animals from a first area to a distant third surface area, while the animals are made to forget the first area by keeping their attention in the third surface area.

In yet a further embodiment, the period of time may comprise a fourth subperiod following the third subperiod; wherein the control unit is configured to control the projection unit, during the fourth subperiod of time, to project the dynamic light spot moving with a curvilinear or linear movement out from the third surface area.

In an embodiment, the dynamic light spot according to the invention may be a plurality of light spots. Hence, the invention may provide a lighting device for illuminating an animal stable, wherein the lighting device comprises a projection unit and a control unit; wherein the projection unit is configured to project a plurality of dynamic light spots within the animal stable, and project each of said plurality of dynamic light spots for a respective period of time, wherein the respective period of time comprises a first subperiod followed by a second subperiod; wherein the control unit is configured to control the projection unit, during the first subperiod of time, to project the respective dynamic light spot of the plurality of light spots to be moving with a pseudorandom or random movement that is confined to a first surface area within the animal stable; and wherein the control unit is configured to control the projection unit, during the second subperiod of time, to project the respective dynamic light spot of the plurality of light spots to be moving with a curvilinear or linear movement out from the first surface area.

In embodiments, the projection of the dynamic light spot may be repeated continuously in operation. Hence, the projection unit according to the present invention may be configured to repeatedly project the dynamic light spot within the animal stable for a period of time.

Phrased differently, in embodiments of the present invention, the projection unit may be configured to project, for a plurality of repeated instances, a dynamic light spot within the animal stable for a period of time, wherein the period of time comprises a first subperiod followed by a second subperiod; wherein the control unit is configured to control, for said plurality of repeated instances, the projection unit, during the first subperiod of time, to project the dynamic light spot moving with a pseudorandom or random movement that is confined to a first surface area within the animal stable; and wherein the control unit is configured to control, for said plurality of repeated instances, the projection unit, during the second subperiod of time, to project the dynamic light spot moving with a curvilinear or linear movement out from the first surface area.

Yet even further, in a related embodiment, the projection unit may be configured to project, for a plurality of repeated instances, a dynamic light spot with a lighting characteristic within the animal stable for a period of time, wherein the period of time comprises a first subperiod followed by a second subperiod; wherein the control unit is configured to control, for said plurality of repeated instances, the projection unit, during the first subperiod of time, to project the dynamic light spot moving with a pseudorandom or random movement that is confined to a first surface area within the animal stable; and wherein the control unit is configured to control, for said plurality of repeated instances, the projection unit, during the second subperiod of time, to project the dynamic light spot moving with a curvilinear or linear movement out from the first surface area; wherein the lighting characteristic of at least one instance of the plurality of repeated instances is different from at least one other instance of the plurality of repeated instances. Said lighting characteristic may for example be one of: a light intensity, a light color, a light spectrum, a color temperature, a light polarization, a projected dynamic light spot pattern. Hence, in a related embodiment, the lighting characteristic may be lighting color, wherein the lighting color of at least one instance of the plurality of repeated instances is different from at least one other instance of the plurality of repeated instances. Such an embodiment may advantageously cope with the habituation of animals to the projected dynamic light spots, and maintain attention during the plurality of repeated instances at which the dynamic light spot is projected.

In aspects, the projection unit according to the invention may be configured to project at least one dynamic light beam for a period of time, wherein each dynamic light beam has a beam divergence of less than 15 degrees and creates said dynamic light spot within the animal stable for a period of time. Said beam divergence may for example be less than 10 degrees, or preferably less than 5 degrees, for example less than 2 degrees. Hence, the dynamic light beam may be collimated beam, such as a dynamic laser beam creating a dynamic laser spot.

In aspects, the projection unit may comprise the control unit. In aspects, the lighting device may comprise a plurality of projection units according to the invention.

It is further an object of the invention to provide an improved method which at least alleviates the problems and disadvantages mentioned above. Thereto, the invention provides a method of illuminating an animal stable, the method comprising: during a first subperiod of time, projecting a dynamic light spot moving with a pseudorandom or random movement that is confined to a first surface area within the animal stable; during a second subperiod of time, projecting a dynamic light spot moving with a curvilinear or linear movement out from the first surface area and in a direction away from a center of the first surface area; wherein the second subperiod follows the first subperiod. Thereby, advantages and/or embodiments applying to the lighting device according to the invention may mutatis mutandis apply to said method according to the invention.

It is further an object of the invention to provide an improved method which at least alleviates the problems and disadvantages mentioned above. Thereto, the invention provides an animal stable comprising at least one lighting device according to the invention.

### BRIEF DESCRIPTION OF THE DRAWINGS

The invention will now be further elucidated by means of the schematic non-limiting drawings:

FIG. 1 depicts schematically an embodiment of a lighting device according to the invention;

FIG. 2 depicts schematically the operation of the embodiment of the lighting device depicted in FIG. 1;

FIG. 3 depicts schematically an embodiment of a lighting device according to the invention, embodied as a luminaire;

FIG. 4 depicts schematically the operation of the embodiment of the lighting device depicted in FIG. 3;

FIG. 5 depicts schematically an embodiment of a method according to the invention.

FIG. 6 depicts schematically examples of the movement pattern of a projected dynamic light spot according to the invention.

### DETAILED DESCRIPTION OF THE EMBODIMENTS

As partly mentioned above: Environmental enrichment for animals with projected laser spots typically implements a random or a pseudorandom movement pattern of the projected laser spots. The effectiveness of such environmental enrichment, and the resulting benefits to animal health and wellbeing, may be negatively affected (over time) by habituation of the animals (i.e. e.g. poultry) to the random or pseudorandom movement pattern of the projected laser spots. The triggered curious response may become lesser due to habituation. Furthermore, there is a need to not only attract the attention of the animals with said laser spots, and get the animals to move and exercise, but also to improve further on the enticed amount of movement or exercise. The present invention provides a lighting device and corresponding method to resolve these disadvantages and problems.

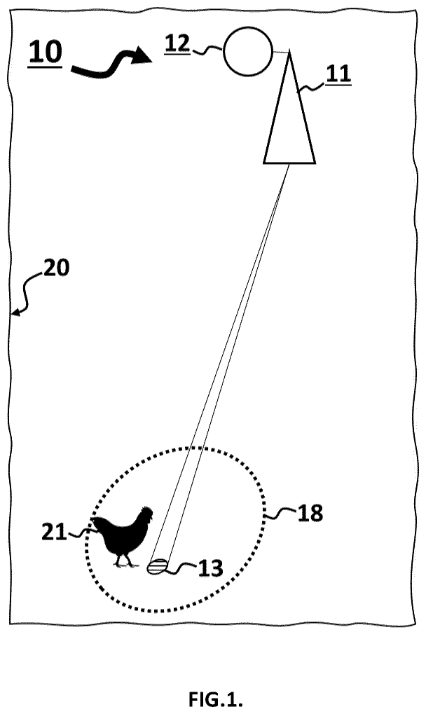

FIG. 1 depicts schematically, by non-limiting example, a lighting device 10 according to the invention. The lighting device may be a luminaire, such as an animal lighting luminaire. The lighting device 10 illuminates an animal stable 20. The animal stable may alternatively be phrased as a livestock environment. The lighting device 10 illuminates at least one animal 21 within the animal stable 20. Here, the animal stable is a poultry coop, and the at least one animal is a chicken 21, such as for example a broiler chicken or a layer chicken. Said at least one animal may alternatively be a plurality of animals, such as a flock of chicken.

The lighting device 10 comprises a projection unit 11 and a control unit 12. The projection unit 11 may be communicatively coupled to the control unit 12. For example, the projection unit 11 may be connected via a wired connected to the control unit, or alternatively via a wireless connection. In some examples, the projection unit may comprise the control unit. Here, the projection unit 11 is a laser lighting unit. This may alternatively be a (high-etendue) spotlight. The projection unit 11 is configured to project a dynamic light spot 13 within the animal stable 20 for a period of time 14. For example, the projection unit 11 may project a dynamic (laser) light beam within the animal stable 18 that has a beam divergence of less than 15 degrees, such as for example less than 5 degrees, wherein the (laser) light beam creates said dynamic light spot 13. The dynamic light spot may comprise a light color, such as for example red, green, blue or white.

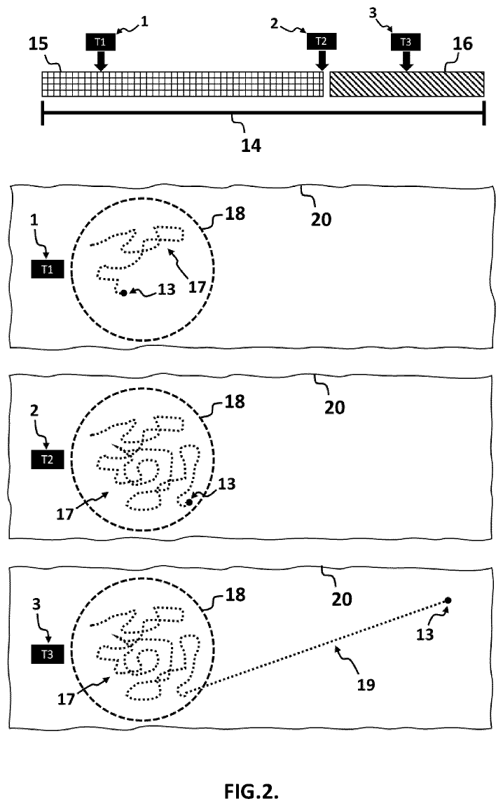

The control unit 12 is configured to control the projection unit 11. FIG. 2 depicts schematically, by non-limiting example, an operation of the projection unit 11 projecting the dynamic light spot 13 for said period of time 14. The period of time 14 thereby defines the period of time that a particular dynamic light spot 13 is projected. This operation may be repeated for a plurality of cycles.

Said period of time 14 comprises a first subperiod 15 followed a second subperiod 16. The second subperiod 16 is thus subsequent (or: consecutive) to the first subperiod 15. Here, the period of time 14 is for example thirty seconds. The first subperiod 15 is for example twenty seconds. The second subperiod 16 is for example ten seconds.

Hence, the time duration of the first subperiod may be at least a factor two longer than a time duration of the second subperiod. Other examples of time durations for the period of time, the first subperiod therein, and the following second subperiod therein, may be similarly envisioned.

Still referring to FIG. 1 and FIG. 2, the control unit 12 controls the projection unit 11, during the first subperiod of time 15, to project the dynamic light spot 13 moving with a pseudorandom or random movement 17 that is confined to a first surface area 18 within the animal stable 20.

More specifically, for illustrative purposes, a first moment in time (T1) referenced with numeral 1 and a second moment in time (T2) reference with numeral 2 are depicted in FIG. 2 occurring in the first subperiod of time 15. A third moment in time (T3) referenced with numeral 3 is depicted in FIG. 2 occurring in the second subperiod of time 16. These ‘snapshots’ in time illustrate the operation of the present invention, more specifically the movement path of the dynamic light spot 13 within the animal stable 20, as it is projected so far (i.e. depicted in dotted path).

Hence, referring to FIG. 2, the dynamic light spot 13 moves, and has moved, with a pseudorandom or random movement 17 at the first moment in time 1 and the second moment in time 2. According to the present invention, as mentioned, the projected dynamic light spot 13 is being projected confined within the first surface area 18.

Here, the first surface area 18 is depicted as a circle, but may alternatively be a square, rectangular, square, polygonal, elliptical, and/or or an organic shape. The first surface area 18 may for example be a part of the floor or bedding of the animal stable. Here, as an example, the first surface area is at most 0.1 square meter.

In an embodiment, the first surface area 18 may be predetermined. For example, the control unit 12 may be configured to obtain a predetermined setting defining the first surface area, and control the projection unit 11 to project the dynamic light spot 13, during the first subperiod of time 15, only within said defined first surface area.

Still referring to FIG. 1 and FIG. 2, since the control unit 12 is configured to control the projection unit 11, during the first subperiod of time 15, to project the dynamic light spot 13 moving with a pseudorandom or random movement 17 that is confined to a first surface area 18 within the animal stable 20, the lighting device 10 according to the invention enables (in other words) a first stage of projection of the dynamic light spot 13 in which the attention of the animal 21 is attracted within the first surface area 18.

However, according to the invention, the control unit 12 controls the projection unit 11, during the second subperiod of time 16, to project the dynamic light spot 13 moving with a curvilinear or linear movement 19 out from the first surface area 18. Namely, out of the first surface area 18 to which the previously projected pseudorandom or random movement was bound to, or confined within.

Said pseudorandom or random movement may alternatively be phrased as pseudorandom or random movement pattern, and said curvilinear or linear movement may alternatively be phrased as curvilinear or linear movement pattern.

Since the control unit 12 is further configured to control the projection unit 11, during the second subperiod of time 16, to project the dynamic light spot 13 moving with a curvilinear or linear movement 19 out from the first surface area 18, the lighting device 10 advantageously enables (in other words) a second stage of projection of the dynamic light spot 13 subsequent to the mentioned first stage, in which the second stage encourages the animal 21 to follow the projected dynamic light spot 13 along a defined pathway, namely to move along a curvilinear or linear path 19 out of the first surface area 18. FIG. 2 depicts a linear path 19 out of the first surface area 18.

Still referring to FIG. 1 and FIG. 2, the curvilinear or linear movement 19 may be defined as a curvilinear or linear movement pattern. Here, the curvilinear or linear movement comprises a path length. The path length may be envisioned accordingly. The path length may be a parameter to tailor the amount of exercise and/or movement provided to the chicken. Here, said path length is at least one meter, but may alternatively be at least two meters. Considering the second subperiod 16 characterizes a locomotion stage of the animal (i.e. the broiler chicken or layer chicken), the projecting unit 11 projecting the dynamic light spot 13 moving with a curvilinear or linear movement 19 out from the first surface area 18 allows for longer trajectories that are easier to track by the animal. Hence, such a locomotion stage is not only beneficial to render health and wellbeing to the animal, due to the enticed physical movement, but also enables relocation of the animal from the first surface area 18 out to another area of interest within in the animal stable 20.

All in all, the lighting device 10 enables environmental enrichment wherein the dynamic light spot(s) are projected in two subsequent stages. Thereby, the first stage (as characterized by the first subperiod 15) being configured to trigger curiosity and attract attention of the animal within the first surface area 18, while the following second stage (as characterized by the second subperiod 16) is configured to entice the animal to move out of the first surface area 18 along a curvilinear or linear path that is easier to follow than a pseudorandom or random pathway. This improves movement of the animal, thereby the Musculo-skeletal development. Thus, the present invention provides a lighting device 10 that improves environmental enrichment even further, and improves animal health and wellbeing.

The movement out from the first surface area may alternatively be phrased as movement away from of the first surface area and out of the first surface area. The movement out from the first surface area may alternatively be phrased as movement out from the first surface area and in a direction away from a center of the first surface area. Said center being a centroid of the first surface area.

The first surface area may alternatively comprise a contour (or: outline). Thereby, alternatively, the control unit may be configured to control the projection unit, during the first subperiod of time, to project the dynamic light spot moving with a pseudorandom or random movement confined within the contour (or: outline) of the first surface area within the animal stable; and the control unit may be configured to control the projection unit, during the second subperiod of time, to project the dynamic light spot moving with a curvilinear or linear movement out from the contour (or: outline) of the first surface area.

In an embodiment, not explicitly depicted, the lighting device as depicted in FIG. 1 and FIG. 2 is provided. Still referring to said lighting device 10, the control unit 12 controls the projection unit 11, during the first subperiod of time 15, to project the dynamic light spot 13 moving with the pseudorandom or random movement 17 at a first movement speed (V1). Moreover, the control unit 12 controls the projection unit 11, during the second subperiod of time 16, to project the dynamic light spot 13 moving with the curvilinear or linear movement 19 out from the first surface area 18 at a second movement speed (V2). The first movement speed (V1) and the second movement speed (V2) may optionally be the same. However, in the present embodiment, as a non-limiting example, the first movement speed (V1) is different from the second movement speed (V2). Namely, the first movement speed (V1) may be tailored to attract the attention of the animal, while the second movement speed (V2) may be tailored to encourage the animal to move away, and out of the first movement area 18. The second movement speed (V2) may for example be larger than the first movement speed (V1). The first movement speed may for example be selected from the range between five and ten centimeter per second. The second movement speed may for example be selected from the range between ten and thirty centimeter per second. In alternative examples, the control unit may obtain an input indicative of a type or identifier of the animal, and determine the first movement speed and/or the second movement speed based on said input, i.e. based on said type or identifier of the animal. The input may also be indicative of an age of the animal.

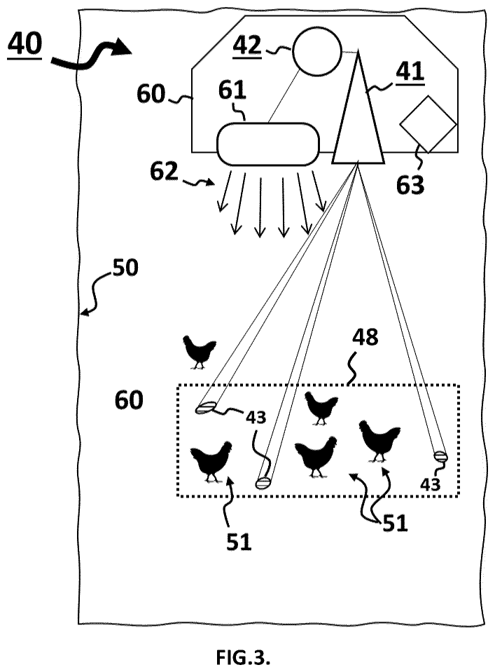

FIG. 3 depicts schematically, by non-limiting example, a lighting device 40 according to the invention. The lighting device 40 illuminates a livestock environment 50. The livestock environment is an animal stable 50, more specifically a poultry farm. The lighting device 40 illuminates a flock of chicken 51 within said poultry farm 50.

The lighting device 40 comprises a projection unit 41, a control unit 42, a light source 61 for providing ambient illumination 62. The lighting device 40 is a luminaire. The luminaire 40 comprises a luminaire housing 60. The luminaire housing 60 comprises the projection unit 41, the control unit 42 and the light source 61. Albeit optionally, the luminaire housing may comprise a sensor unit 63.

The projection unit 41 may be communicatively coupled to the control unit 42. Here, the projection unit 41 is a laser lighting unit. This may alternatively be a (high-etendue) spotlight. The projection unit 41 is configured to project a plurality of dynamic light spots 43 within the animal stable 50. Alternatively, the projection unit may project a single dynamic light spot. Each light spot 43 of the plurality of dynamic light spots 43 is projected for respective a period of time 44. For example, the projection unit 41 may project a plurality of dynamic (laser) light beams within the poultry farm 50, wherein each dynamic (laser) light beam has a beam divergence of less than 15 degrees and creates a respective dynamic light spot 43. Each dynamic light spot may comprise a light color, such as for example red, green, blue or white.

In embodiments, the projection of each dynamic light spot of the plurality of dynamic light spots may be repeated continuously in operation. Hence, the projection unit according to the present invention may be configured to repeatedly project each dynamic light spot (of the plurality of dynamic light spots) within the animal stable for a respective period of time.

The light source 61 may be communicatively coupled to the control unit 42. The light source 61 illuminates at least part of the poultry farm 50 with an ambient light recipe. The ambient light recipe may for example be a functional light. The ambient light recipe may for example be an animal light recipe, such as for example the trademarked Junglite Green light recipe of the company Signify-ONCE. This is advantageous, because the same luminaire 40 may provide both environmental enrichment, as well as ambient lighting 62, such as animal lighting recipes.

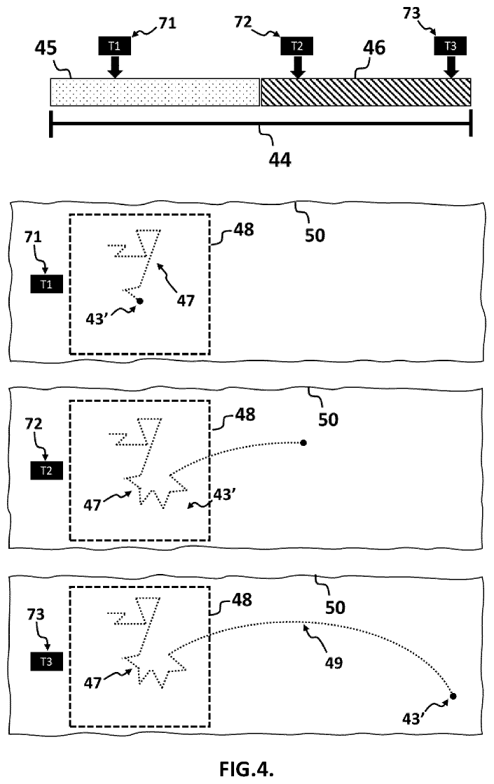

Still referring to FIG. 3, the control unit 42 is configured to control the projection unit 41 to project each of said plurality of light spots 43. FIG. 4 depicts schematically, by non-limiting example, an operation of the projection unit 41 projecting the dynamic light spot 43 for said period of time 44. The period of time 44 thereby defines the period of time that a particular dynamic light spot 43 is projected (of the plurality of light spots that are projected). For each light spot, this operation may be repeated for a plurality of cycles.

Said period of time 44 comprises a first subperiod 45 followed a second subperiod 46. The second subperiod 46 is thus subsequent (or: consecutive) to the first subperiod 45. Here, the period of time 44 is for example twenty seconds. The first subperiod 45 is for example ten seconds. The second subperiod 46 is for example ten seconds. Other examples of time durations for the period of time, the first subperiod therein, and the following second subperiod therein, may be similarly envisioned.

Still referring to FIG. 3 and FIG. 4, the control unit 42 controls the projection unit 41, during the first subperiod of time 45, to project each respective dynamic light spot of the plurality of light spots 43 to be moving with a pseudorandom or random movement 47 that is confined to a first surface area 48 within the animal stable 50. Here, the first surface area 48 is depicted as a rectangular surface area. The first surface area 48 may for example be at most 0.25 square meter, such as for example at most 0.1 square meter.

More specifically, for illustrative purposes, a first moment in time (T1) referenced with numeral 71, a second moment in time (T2) referenced with numeral 72, and a third moment in time (T3) referenced with numeral 73, are depicted in FIG. 4 occurring in the period of time 44. The first moment in time (T1) occurs in the first subperiod of time 45. The second (T2) and third moment in time (T3) occur in the second subperiod of time 46. These ‘snapshots’ in time illustrate the operation of the present invention, more specifically the movement path of a respective dynamic light spot of the projected plurality of light spots 43 within the animal stable 20; as it is projected so far (i.e. depicted in dotted path).

Hence, a respective dynamic light spot 43′ of the plurality of light spots 43 moves, and has moved, with a pseudorandom or random movement 47 confined within the first surface area 48 at the first moment in time 71. Thus, as mentioned, said projected dynamic light spot 43′ is being projected confined within the first surface area 48.

Still referring to FIG. 3 and FIG. 4, since the control unit 42 is configured to control the projection unit 41, during the first subperiod of time 45, to project each respective dynamic light spot of the plurality of light spots 43 to be moving with a pseudorandom or random movement 47 that is confined to a first surface area 48 within the animal stable 50, the lighting device 40 according to the invention enables (in other words) a first stage of projection of the dynamic light spot 43 in which the attention of the flock of chicken 51 is attracted within the first surface area 48.

However, according to the invention, the control unit 42 controls the projection unit 41, during the second subperiod of time 46, to project the respective dynamic light spot 43′ of the plurality of light spots 43 to be moving with a curvilinear or linear movement 49 out from the first surface area 48. Namely, out of the first surface area 48 to which the previously projected pseudorandom or random movement was bound to, or confined within. Here, said movement is curvilinear out from the first surface area 48, but may alternatively be linear movement out from the first surface area.

Since the control unit 42 is further configured to control the projection unit 42, during the second subperiod of time 46, to project the respective dynamic light spot 43′ of the plurality of light spots 43 to be moving with the curvilinear movement 49 out from the first surface area 48, the lighting device 40 advantageously enables (in other words) a second stage of projection of the dynamic light spot 43 subsequent to the mentioned first stage, in which the second stage encourages the animal 51 to follow the projected respective dynamic light spot 43′ along a defined pathway, namely to move along the curvilinear path 49 out of the first surface area 48. FIG. 4 depicts the curvilinear path 49 out of the first surface area 48, as can be seen at the ‘snapshots’ depicted at time T2 and T3.

Still referring to FIG. 3 and FIG. 4, the curvilinear movement comprises a path length. The path length may be envisioned accordingly. The path length may be a parameter to tailor the amount of exercise and/or movement provided to the chicken of the flock of chicken 51. Here, said path length is at least two meters, such as for example four meters. Considering the second subperiod 46 characterizes a locomotion stage of chicken, the projecting unit 41 projecting the dynamic light spot 43 moving with the curvilinear movement 49 out from the first surface area 48 allows for longer trajectories that are easier to track by the chicken. Hence, such a locomotion stage is not only beneficial to render health and wellbeing to the chicken of the flock of chicken 51, due to the enticed physical movement, but also enables relocation of the animal from the first surface area 48 out to another area of interest within in the animal stable 50.

Still referring to FIG. 3, as mentioned but optionally, the luminaire housing may comprise a sensor unit 63. Here, the sensor unit 63 is configured to determine an activity level of the flock of chicken 51, particularly in the first surface area 48. The sensor unit 63 is configured to convey, in optional examples, said determined activity level of the flock of chicken 51 to the sensor unit 42 by means of a sensor input signal. Hence, in such optional examples, the control unit 42 is configured to obtain a sensor input signal indicative of an activity level of the flock of chicken 51 within the poultry farm 50, namely an activity level of the flock of chicken 51 in the first surface area 48, and determine said activity level. The control unit 42 is further configured to control the projection unit 41 to project a dynamic light spot of the plurality of dynamic light spots 43 within the animal stable 50 for said period of time 44 if the determined activity level is below a predefined threshold value. Since the activity level of the chicken is indicative of their current movement and/or exercise, such an optional example is advantageous, because the projection of the plurality of dynamic light spot 43 within the animal stable for said period of time only occurs upon determining that the activity level is below a predefined threshold value.

Yet in further optional embodiments, the control unit controls the projection unit, during the first subperiod of time, to project each respective dynamic light spot of the plurality of dynamic light spots to be moving with the pseudorandom or random movement at a first movement speed. Moreover, the control unit controls the projection unit, during the second subperiod of time, to project each dynamic light spot of the plurality of dynamic light spots to be moving with the curvilinear or linear movement out from the first surface area at a second movement speed. The first movement speed and the second movement speed may thereby be selected based on the sensor input signal, and hence the activity level of the flock of chicken. A higher activity level may render a higher movement speed.

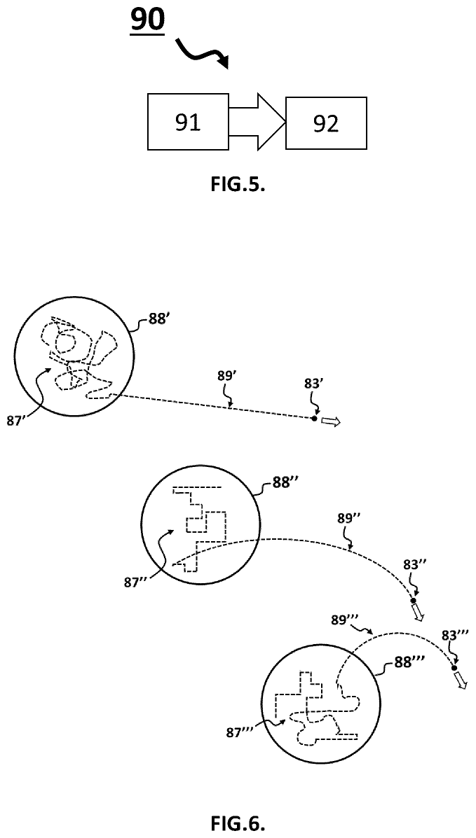

FIG. 5 depicts schematically, by non-limiting example, a method 90 of illuminating an animal stable according to the invention. The method 90 can be performed by the lighting device according to the invention. The method 90 comprises a step 91 of: during a first subperiod of time, projecting a dynamic light spot moving with a pseudorandom or random movement that is confined to a first surface area within the animal stable. The method 90 comprises a step 92 of: during a second subperiod of time, projecting a dynamic light spot moving with a curvilinear or linear movement out from the first surface area; wherein the second subperiod follows the first subperiod.

FIG. 6 depicts schematically, by non-limiting example, three examples of the movement pattern of a projected dynamic light spot according to the invention. Namely: a projected first dynamic light spot 88′, a projected second dynamic light spot 88″, and a projected third dynamic light spot 88′″.

The projection unit according to the invention is configured to project a dynamic light spot within the animal stable for a period of time, wherein the period of time comprises a first subperiod followed by a second subperiod. These dynamic light spots may be projected repeatedly.

Considering a projected first dynamic light spot 88′: The control unit according to the invention is configured to control the projection unit, during the first subperiod of time, to project the first dynamic light spot 88′to be moving with a random movement 87′ (or: random movement pattern) that is confined to a first surface area 88′ within an animal stable. Said control unit is also configured to control the projection unit, during the second subperiod of time, to project the first dynamic light spot 88′to be moving with a linear movement 89′ (or: linear movement pattern) out from the first surface area 88′. Considering a projected second dynamic light spot 88″: The control unit according to the invention is configured to control the projection unit, during the first subperiod of time, to project the second dynamic light spot 88″ to be moving with a pseudorandom movement 87″ (or: pseudorandom movement pattern) that is confined to a first surface area 88″ within an animal stable. Said control unit is also configured to control the projection unit, during the second subperiod of time, to project the second dynamic light spot 88″ to be moving with a curvilinear movement 89″ (or: curvilinear movement pattern) out from the first surface area 88″.

Considering a projected third dynamic light spot 88″′: The control unit according to the invention is configured to control the projection unit, during the first subperiod of time, to project the third dynamic light spot 88″′ to be moving with a pseudorandom movement 87″ (or: pseudorandom movement pattern) that is confined to a first surface area 88″ within an animal stable. Said control unit is also configured to control the projection unit, during the second subperiod of time, to project the third dynamic light spot 88″ to be moving with a curvilinear movement 89″ (or: curvilinear movement pattern) out from the first surface area 88″′. Here, said curvilinear movement is a circular movement, or phrased differently, during the second subperiod, the third dynamic light spot 88″′ is moving along a curvilinear path away from the first surface area 88′″. In alternative aspects, a radius of said curvilinear path may be at least a factor 10 larger than an effective diameter of said first surface area 88′″.

The movement out from the first surface area may alternatively be phrased as movement away from of the first surface area and out of the first surface area. The movement out from the first surface area may alternatively be phrased as movement out from the first surface area and in a direction away from a center of the first surface area. Said center being a centroid of the first surface area.

1. A lighting device for illuminating an animal stable, wherein the lighting device comprises a projection unit and a control unit;
wherein the projection unit is configured to project a dynamic light spot within the animal stable for a period of time, wherein the period of time comprises a first subperiod followed by a second subperiod;
wherein the control unit is configured to control the projection unit, during the first subperiod of time, to project the dynamic light spot moving with a pseudorandom or random movement that is confined within a contour of a first surface area within the animal stable; and
wherein the control unit is configured to control the projection unit, during the second subperiod of time, to project the dynamic light spot moving with a curvilinear or linear movement out from the contour of the first surface area and in a direction away from a center of the first surface area and to another area within the animal stable.

2. The lighting device according to claim 1, wherein the projection unit is a laser lighting unit, wherein the dynamic light spot is a dynamic laser light spot.

3. The lighting device according to claim 1, wherein the projection unit is a high-etendue spotlight, wherein the dynamic light spot is a high-etendue dynamic light spot.

4. The lighting device according to claim 1, wherein the period of time is at most thirty seconds.

5. The lighting device according to claim 1, wherein a time duration of the first subperiod is at least a factor two longer than a time duration of the second subperiod.

6. The lighting device according to claim 1, wherein the curvilinear or linear movement comprises a path length; wherein the path length is at least one meter.

7. The lighting device according to claim 1, wherein the control unit is configured to control the projection unit, during the first subperiod of time, to project the dynamic light spot moving with the pseudorandom or random movement at a first movement speed;
wherein the control unit is configured to control the projection unit, during the second subperiod of time, to project the dynamic light spot moving with the curvilinear or linear movement out from the first surface area at a second movement speed;
wherein the first movement speed is different from the second movement speed.

8. The lighting device according to claim 7, wherein the second movement speed is larger than the first movement speed.

9. The lighting device according to claim 7, wherein the first movement speed is selected from the range between five and ten centimeter per second.

10. The lighting device according to claim 1, wherein the animal stable is a poultry coop.

11. The lighting device according to claim 1, wherein the first surface area is at most 0.1 square meter.

12. The lighting device according to claim 1, wherein the period of time may comprise a third subperiod following the second subperiod;
wherein the control unit is configured to control the projection unit, during the third subperiod of time, to project the dynamic light spot moving with a pseudorandom or random movement that is confined to a third surface area within the animal stable;
wherein the third surface area is outside the first surface area; wherein the third surface area is at a distance from the first surface area.

13. The lighting device according to claim 1, wherein the control unit is configured to obtain a sensor input signal indicative of an activity level of animals within the animal stable and determine said activity level;
wherein the control unit is configured to control the projection unit to project the dynamic light spot within the animal stable for said period of time if the determined activity level is below a predefined threshold value.

14. A method of illuminating an animal stable, the method comprising:
during a first subperiod of time, projecting a dynamic light spot moving with a pseudorandom or random movement that is confined to a first surface area within the animal stable;
during a second subperiod of time, projecting a dynamic light spot moving with a curvilinear or linear movement out from the first surface area and in a direction away from a center of the first surface area;
wherein the second subperiod follows the first subperiod.

15. An animal stable comprising at least one lighting device according to claim 1.
